(19) United States
(12) Patent Application Publication
(10) Pub. No.: US 2004/0067705 A1
(43) Pub. Date: Apr. 8, 2004

(54) Process of bonding and composites made therefrom

(75) Inventors: Minh-Tan Ton-That, Montreal (CA); Johanne Denault, Longueuil (CA); Patrick Gagnon, Laval des Rapides (CA)

Correspondence Address: ANISSIMOFF & ASSOCIATES, RICHMOND NORTH OFFICE CENTRE, SUITE 201, 235 NORTH CENTRE RD., LONDON, ON, N5X 4E7, CA

(73) Assignee: National Research Council of Canada

(21) Appl. No.: 10/678,150

(22) Filed: Oct. 6, 2003

Related U.S. Application Data
(60) Provisional application No. 60/416,417, filed on Oct. 7, 2002.
(60) Provisional application No. 60/431,992, filed on Dec. 10, 2002.

(51) Int. Cl. B32B 27/04

(52) U.S. Cl. 442/65; 156/309.6

(57) ABSTRACT

There is provided a composite comprising an interlayer disposed between a first interpenetrating layer and a second interpenetrating layer, the interlayer consisting essentially of a porous material, the first interpenetrating layer partially interpenetrating the interlayer, and the second interpenetrating layer partially interpenetrating the interlayer. There is also provided a process for bonding, the process comprising: providing an interlayer consisting essentially of a porous material; partially interpenetrating the interlayer with a first interpenetrating layer; and partially interpenetrating the interlayer with a second interpenetrating layer. The composite and process are useful in the assembly, repair and insertion of articles.

This application claims the benefit of U.S. patent application Ser. No. 60/416,417 filed Oct. 7, 2002 and U.S. patent application Ser. No. 60/431,992 filed Dec. 10, 2002.

### FIELD OF THE INVENTION

The present invention relates to a process for bonding together layers of similar or dissimilar materials and to composites prepared thereby. In particular, the present invention relates to composites and processes for assembling, repairing or inserting articles comprising similar or dissimilar materials.

### BACKGROUND OF THE INVENTION

Assembly is one of the most important issues in the production and usage of all kinds of products. In the production stage, for large parts or parts with a complicated profile, small parts are often made and then assembled in order to solve technical problems and/or improve cost effectiveness. In addition, assembly is sometimes also involved in the finishing steps, like strengthening of certain areas of the products or attaching inserts, etc. During service, reparability is a large concern for all newly developed products since it determines the cost effectiveness of the product. Assembly and repair are not easy issues since they involve different aspects of material, process and design. Assembly and repair of dissimilar materials becomes much more complicated due to the incompatibility in the materials' characteristics and behavior.

Different assembly and repair technologies have been developed and examined for both similar and dissimilar materials. Fusion bonding is often used for meltable materials, like metals and thermoplastics, in which two substrates are brought to the molten stage to permit inter-diffusion of the molecules of the two materials at this interface. In the case of non-fusible materials, mechanical techniques may also be used in which the bond is formed by rivets or screws or the like. Alternatively, adhesive bonding is an efficient and popular joining technique, in which the adhesive is chosen to provide a good adhesion with the two substrates, either physically or chemically.

Mechanical techniques face problems of stress concentration at the holes while fusion bonding is not always possible for dissimilar materials and adhesive bonding sometimes cannot handle the incompatibility of different substrates. In addition, adhesive bonding is very sensitive to environment, such as humidity, temperature, solvent, etc.

Don et al. describe in U.S. Pat. No. 5,643,390 a process for promoting adhesion between polystyrene or polyetherimide thermoplastics and bismaleic thermosets by using a thermoplastic hybrid interlayer (THIL). The THIL is a hybrid of thermoplastic (e.g. polyphenylene sulphide) and a material containing pores, holes, pits, perforation or the like (e.g. carbon fibers). The thermoplastic in the THIL has to be amorphous and compatible with the desired thermoset, thus limiting the application and generality of this method.

There still remains a need for generally applicable alternative methods of bonding together similar and dissimilar materials.

### SUMMARY OF THE INVENTION

There is provided a composite comprising an interlayer disposed between a first interpenetrating layer and a second interpenetrating layer, the interlayer consisting essentially of a porous material, the first interpenetrating layer partially interpenetrating the interlayer, and the second interpenetrating layer partially interpenetrating the interlayer.

There is also provided a process for bonding, the process comprising: providing an interlayer consisting essentially of a porous material; partially interpenetrating the interlayer with a first interpenetrating layer; and partially interpenetrating the interlayer with a second interpenetrating layer.

The use of an interlayer consisting essentially of a porous material permits greater flexibility in bonding processes. Unlike prior art methods which employ thermoplastic hybrid interlayers (THILs), the process of the present invention enables the bonding of virtually any type of materials. Thus, the process of the present invention is more generally applicable to the assembly, repair and insertion of a wider variety of articles. Furthermore, the process of the present invention permits assembly, repair or insertion of articles at any point in the lifetime of an article, for example, concurrently with fabrication or off-line at any time during or after fabrication. Additionally, bonds created by the process of the present invention are often stronger than the bonds resulting from methods which use thermoplastic hybrid interlayers.

While the interpenetrating layers themselves may act as substrates in the assembly, repair or insertion of articles, it is also possible for one or more other substrates to be bonded to one or more of the interpenetrating layers to form structures having yet more layers.

Further features of the invention will be described or will become apparent in the course of the following detailed description.

### DETAILED DESCRIPTION

Layers:

The interlayer consists essentially of a porous material. The porous material may be any material which has cavities, pits, holes, perforations, pores, or the like, into which the interpenetrating layers can diffuse. By not pre-impregnating the porous material with a thermoplastic substance (as with THILs), the porous material of the interlayer of the present invention has more capacity for accepting the interpenetrating layers, and, avoids problems arising from incompatibility between the interpenetrating layers and the thermoplastic substance.

The porous material may be, for example, fibrous mats, scrims or fabrics, pitted or perforated metal strips or blocks, porous clays, among others. Fibrous mats, scrims and fabrics are of particular note as fibers may maximize the interaction between the interlayer and the interpenetrating layers thereby providing a stronger mechanical bond. The fibers may comprise any substance which is formable into fibers. For example, glass fibers, metallic fibers (including alloys), metallic oxide fibers, ceramic fibers, cellulose fibers, asbestos fibers, plastic fibers (including homopolymers, copolymers and polymer blends) such as polyester fibers, carbon fibers, among others are all formable into mats, scrims or fabrics, which are useful as porous materials in the interlayer of the present invention. The fibers may also be hybrid fibers constructed from two or more different types of fibers or may have different fiber diameters and densities. The choice of porous material and the substance of which the porous material is comprised may depend to some extent on the nature of interpenetrating layers. Good compatibility between the interlayer substance and the interpenetrating layers is advantageous, but not essential since the bond strength is primarily determined by the mechanical interlock between the interlayer and the interpenetrating layers. In hybrid fibers, it is preferred that at least one of the types fibers is compatible with the interpenetrating layer or layers.

The texture of the interlayer can be specifically designed in order to optimize interlock strength between the interlayer and an interpenetrating layer under conditions of shear, peel, twist or a combination thereof, depending on the specific application of the composite. When one or more other substrates are bonded to one or more of the interpenetrating layers, it is preferred that the interpenetrating layers have good compatibility with the substrates with which they are in contact and have good compatibility with the interlayer. When different interpenetrating layers are used, it is preferred that the two interpenetrating layers have better compatibility between each other than the compatibility that would have existed between the other substrates if the other substrates were used as the interpenetrating layers. In addition, interlayer thickness may be controlled to reduce stress concentration in the composite.

The interpenetrating layers and the other substrates may be the same or different in any combination and may comprise virtually any substance. For example, the interpenetrating layers and/or the other substrates may comprise a polymer (e.g. thermoplastic, thermoset, elastomer), a metal or metal alloy (e.g. aluminum, titanium, copper, brass, tin, bronze, iron, steel), a glass (e.g. soda lime glass, borosilicate glass, lead glass, electronic glass, opal glass, etc.), a ceramic, a composite thereof, or any combination thereof.

Some suitable thermoplastic polymers include, for example, olefinics (i.e. polyolefins), vinylics, styrenics, acrylonitrilics, acrylics, cellulosics, polyamides, thermoplastic polyesters, thermoplastic polycarbonates, polysulfones, polyimides, polyether/oxides, polyketones, fluoropolymers, copolymers thereof, or mixtures thereof.

Some suitable olefinics (i.e. polyolefins) include, for example, polyethylenes (e.g. LDPE, HDPE, LLDPE, UHMWPE, XLPE, copolymers of a ethylene with another monomer), polypropylene, polybutylene, polymethylpentene, or mixtures thereof. Some suitable vinylics include, for example, polyvinylchloride, chlorinated polyvinylchloride, vinyl chloride-based copolymers, polyvinylidenechloride, polyvinylacetate, polyvinylalcohol, polyvinyl aldehydics (e.g. polyvinylacetal), polyvinylalkylethers, polyvinylpyrrolidone, polyvinylcarbazole, polyvinylpyridine, or mixtures thereof. Some suitable styrenics include, for example, polystyrene, polyparamethylstyrene, polyalphamethylstyrene, high impact polystyrene, styrene-based copolymers, or mixtures thereof. Some suitable acrylonitrilics include, for example, polyacrylonitrile, polymethylacrylonitrile, acrylonitrle-based copolymers, or mixtures thereof. Some suitable acrylics include, for example, polyacrylicacid, polymethacrylicacid, polymethacrylate, polyethylacrylate, polybutylacrylate, polymethylmethacrylate, polyethylmethacrylate, cyanoacrylate resins, hydroxymethylmethacrylate, polacrylamide, or mixtures thereof. Some suitable cellulosics include, for example, cellulose, cellulose esters, celluloseacetates, mixed cellulosic organic esters, cellulose ethers, methylcellulose, ethylcellulose, carboxymethylcellulose, hydroxyethylcellulose, or mixtures thereof. Some suitable polyamides include, for example, aliphatic polyamides (e.g. nylons), aromatic polyamides, transparent polyamides, or mixtures thereof. Some suitable thermoplastic polyesters/polycarbonates are, for example, polyalkylene terephthalates (e.g. polyethylene terephthalate), polycyclohexanedimethanol terephthalates, polyarylesters (e.g. polyarylates), polycarbonate, or mixtures thereof. Some suitable polysulfones include, for example, diphenylsulfone, polybisphenolsulfone, polyethersulfone, polyphenylethersulfones, or mixtures thereof. Some suitable polyimides include, for example, polyamideimide, polyetherimide, or mixtures thereof. Some suitable polyether/oxides include, for example, polymethyleneoxides, polyethyleneoxide, polypropyleneoxide, polyphenyleneoxides, or mixtures thereof. Some suitable polyketones include, for example, polyetheretherketone-1. Some suitable fluropolymers include, for example, polytetrafluoroethylene, polychlorotrifluoroethylene, polyvinylfluoride, polyvinylidenefluoride, polyperfluoroalkoxy, polyhexafluoropropylene, polyhexafluoroisobutylene, fluoroplastic copolymers, or mixtures thereof.

Some suitable thermosets, include, for example, formaldehyde systems, furan systems, allyl systems, alkyd systems, unsaturated polyester systems, vinyester systems, epoxy systems, urethane/urea systems, or mixtures thereof.

Some suitable formaldehyde systems include, for example, urea-formaldehyde resins, melamine-formaldehyde resins, phenol-formaldehyde resins, mixtures thereof. Some suitable furan systems include, for example, furan resins, furfural resins, furfuryl alcohol resins, or mixtures thereof. Some suitable allyl systems include, for example, di‘allyl’phthalate, di‘allyl’isophthalate, di‘ethylene’glycol‘bis’allyl’carbonate, or mixtures thereof. Some suitable alkyd systems include, for example, the reaction of ethylene glycol glycerol and phthalic acid with fatty acids. Some suitable unsaturated polyester systems include, for example, one component which is a polyester product of a reaction between a difunctional acid or anhydride (e.g. maleic acid, maleic anhydride, phthalic anhydride, terephthalic acid) with a difunctional alcohol (e.g. ehtylene glycol, propylene glycol, glycerol), and, a second component which is a monomer capable of polymerizing and reacting with unsaturations in the polyester component (e.g. styrene, alphamethylstyrene, methylmethacrylate, diallylphthalate). Some suitable vinylester systems include, for example, the reaction of diglycidyl ether of bisphenol A with methacrylic acid. Some suitable epoxy systems include, for example, the reaction between epichlorohydrin and a multifunctional acid, amine or alcohol. Some suitable urethane/urea systems include, for example, the reaction product of a liquid isocyanate (e.g. 2,4-toluenediisocyanate, 2,6-toluenediisocyanate) and a polyol (e.g. polyethylene ether glycol, polypropylene ether glycol).

Some suitable elastomers include, for example, polyisoprene, polybutadiene, polychloroprene, polyisobutylene, styrene-butadiene rubber, acrylonitrile-butadiene rubber, ethylene-propylene rubber, ethylene-propylene-diene rubber, chlorinated polyethylene, chlorosulfonated polyethylene, ethylene-vinylacetate copolymer, ethylene-acrylate copolymer, fluoroelastomers (e.g. polyvinyliden polychlorotrifluoroethylene), silicone polymers (e.g. polydimethylsiloxane), acrylic rubber, epichlorohydrin rubber, polysulfide rubbers, propyleneoxide rubbers, polynorbornene, polyorganophosphazenes, olefinic thermoplastic rubbers, styrenic thermoplastic rubbers, urethane thermoplastic rubbers, etherester thermoplastic rubbers, etheramide thermoplastic rubbers, or mixtures thereof.

Composites:

In composites prepared by a process of the present invention, the layers may be oriented in any manner with respect to each other. For example, if the interlayer takes a block-like shape, the first interpenetrating layer may be bonded to one face of the interlayer and the second interpenetrating layer bonded to an opposite or adjacent face of the interlayer. Such an arrangement would further permit bonding the first and/or second interpenetrating layer to other faces of the interlayer and would even permit the bonding of a third, fourth, etc. interpenetrating layer to the same interlayer. Thus, the nature and shape of the interlayer provides flexibility in how the assembly, repair or insertion of an article may be accomplished.

In addition, after an interpenetrating layer has been bonded to the interlayer, another substrate may be, if desired, bonded to the interpenetrating layer to further build up the composite. In the case where no other substrates are bonded to the interpenetrating layer, the interpenetrating layer itself may be considered a substrate of the composite. Bonding of another substrate to the interpenetrating layer may be accomplished by any suitable means known in the art. For example, the other substrate may be bonded to the interpenetrating layers by adhesion bonding, by fusion bonding (e.g. lamination), etc. In this case, it may be advantageous to use interpenetrating layers, which are easy to assemble with the other substrates by the aforementioned bonding techniques thereby increasing the flexibility and simplicity of the process of bonding.

Furthermore, multiply layered composites having more than one interlayer may be formed by a process of the present invention. Thus it is possible, for example, to form a composite comprising a first, second and third interpenetrating layer by having a first interlayer disposed between the first and second interpenetrating layers and a second interlayer disposed between the second and third interpenetrating layers. A composite with any number of layers may be formed in this manner. Such multiply layered composites may be further built up by bonding other substrates to the interpenetrating layers in a manner similar to the one described above.

In one embodiment, it is advantageous that the interlayer be relatively flat having substantially only two surfaces on to which interpenetrating layers may be bonded. Such an interlayer may come in the form of a mat, scrim, fabric, sheet or strip of porous material. In such an embodiment, the first interpenetrating layer will be bonded to a side of the interlayer opposite that of the second interpenetrating layer, thus forming a three layer structure in which the interlayer is disposed between the first and second interpenetrating layers in a linearly sequential relationship. This arrangement is particularly advantageous for repair, but is also useful in assembly and insertion of articles.

Processes:

A process for bonding together layers of material generally comprises the steps of providing an interlayer consisting essentially of a porous material; partially interpenetrating the interlayer with a first interpenetrating layer; and partially interpenetrating the interlayer with a second interpenetrating layer. In this process, the first and second interpenetrating layers partially interpenetrate or diffuse into the interlayer thus creating a strong mechanical bond between the interlayer and each of the interpenetrating layers, effectively creating a strong bond between the two interpenetrating layers. The nature of the interpenetrating layers is not as important as in other bonding techniques since the strength of the bond arises from the mechanical interlocking of the interpenetrating layers with the interlayer. Thus, even normally incompatible interpenetrating layers may be conveniently bonded together using a process of the present invention.

In one embodiment, the first and second interpenetrating layers may comprise the same substance. While not essential, using the same substance for both the first and second interpenetrating layers enhances bonding since the two interpenetrating layers would be completely compatible. The decision to use the same or different substance in the first and second interpenetrating layers depends on the application. When it is desired to assemble, repair or insert articles comprising the same substrate, the interpenetrating layers could comprise the same substance since the substrates which will be bonded to the interpenetrated interlayer will be the same. When bonding together substrates made of different substances, it may be advantageous to use different substances in each of the interpenetrating layers, wherein the substance used in each of the interpenetrating layers would be chosen to be compatible with the respective substrates to which the interpenetrating layers are to be bonded.

An existing substrate may be bonded directly to a porous material. For example, a lamination process may be used wherein a surface of the substrate is melted and the melted substrate forms an interpenetrating layer which interpenetrates the porous material. In some cases, however, it is advantageous to use a separate interpenetrating layer followed by bonding the substrate to the interpenetrating layer. The latter process permits the use of raw materials, rather than an existing substrate, in the formation of the interpenetrating layer, which leads to better control of interpenetration. Raw materials may come in a variety of forms, for example, as powders, liquids or solutions, which facilitate interpenetration. The use of a separate interpenetrating layer may be particularly advantageous in the repair of articles.

The process of bonding each interpenetrating layer to the interlayer may conducted sequentially or at the same time, continuously or discontinuously. Preferably, the process is conducted sequentially such that one of the interpenetrating layers is partially interpenetrated into the interlayer followed by interpenetration of the next interpenetrating layer, and so forth until all desired interpenetrating layers are bonded to the interlayer. In order to maximize the bonding effect for each interpenetrating layer, it is important that the interpenetration of each preceding interpenetrating layer be partial so that some of the porous substrate of the interlayer is available for interpenetration by the successive interpenetrating layers. Once all of the interpenetrating layers have been bonded to the interlayer, the interlayer may be fully interpenetrated by the combined interpenetration of all of the interpenetrating layers.

There are many variations of the process which may be contemplated, some of which are described below.

Where an interpenetrating layer is meltable, such as with thermoplastic polymers, with some elastomers and with some metals or metal alloys, it is possible to melt the surface of the interpenetrating layer and apply the porous material directly to the melted surface of the interpenetrating layer. In order to achieve partial interpenetration of the melted interpenetrating layer into the interlayer, it is necessary to control the extent of surface melting of the interpenetrating layer. It is desirable to melt just enough of the surface so that only part of the interlayer is interpenetrated, leaving room for the next interpenetrating layer to be bonded to the interlayer. The process may be facilitated if the interpenetrating layer is provided in film form. Providing the interpenetrating layer in a film of specific thickness permits control over the extent of interpenetration of the interpenetrating layer in the interlayer.

Melting of the surface of the interpenetrating layer can be accomplished and controlled by any convenient method. For example, hot plates, heat guns and infrared emitters may all be used for this purpose. Welding techniques, for example, resistance welding, ultrasonic welding and vibration welding, etc., may also be used. Molding techniques, for example injection molding, compression molding, thermoforming-stamping, vacuum molding, autoclave processing, calendaring, extrusion, pultrusion, roll-forming, etc., may also be used. Injection molding is very suitable in embodiments where the interlayer has already been bonded to one or more interpenetrating layers and the final interpenetrating layer is to be applied. In this embodiment, the assembled component system without the final interpenetrating layer can be placed in a mold and a melt of the final interpenetrating layer injected into the mold where it interpenetrates the rest of the interlayer to form an interlock. After the initial bonding of the interpenetrating layer to the interlayer, further processing may be done depending the type of material layer used. For example, elastomers may be further vulcanized, thermoplastic polymers may undergo cross-linking, etc.

Where an interpenetrating layer is not meltable, for example thermosets and ceramics, other techniques must be used to bond the interpenetrating layer to the interlayer. In the case of thermosets, one technique is to coat and partially interpenetrate the interlayer with a monomer or monomers followed by curing to form a thermoset polymer interpenetrating layer which partially interpenetrates and is bonded to the interlayer. With ceramics, it is possible to form a green body comprising the desired ceramic materials by first forming a wet mixture of the ceramic components and partially interpenetrating the wet mixture into the interlayer, followed by drying to form the green body. The green body may then be sintered or hot-pressed to form a ceramic interpenetrating layer partially interpenetrated in the interlayer. In such a technique, it is often desirable to process the green body at a temperature less than the melting temperature of the porous material of the interlayer in order to maintain the porous nature of the interlayer.

In another embodiment, it is possible to use an adhesive as one or more of the interpenetrating layers which interpenetrate the interlayer. For example, the adhesive may be coated on to an existing substrate and the interlayer applied to the adhesive such that the adhesive partially interpenetrates the interlayer. The adhesive thus acts to bind the interlayer to the substrate. Such a technique is particularly useful for repair where there is an existing substrate. This technique is even more particularly useful when the existing substrate is a thermoset, a ceramic or a metal or metal alloy, since many of the previously mentioned techniques may be inapplicable. The adhesive is typically chosen for compatibility with the substrate since the bonding of the adhesive to the interlayer is accomplished by mechanical interlock, making compatibility between the adhesive and the interlayer a relatively minor issue. Suitable adhesives for particular substrates are well known and one skilled in the art would have little trouble making an appropriate selection. For example, epoxy, polyurethane and acrylic adhesives are well known for adhesion of many different substrates, including metals, ceramics, and plastics. For porous and flexible materials, like leather, textile, elastomer, etc, rubber based adhesives or the like are recommended.

In addition, concentration of the interpenetrating layers in the interlayer can affect adhesion. For example, an increase of the fiber content of the interlayer will increase the number of interlock sites ultimately increasing adhesion between the substrates. However, the amount of the interpenetrating layers is still preferably sufficient to fill up voids in the interlayer in order to reduce stress concentration in the interlayer which can negatively affect the bond. Pressure can be used to optimize the formation of the bond, such as by impregnation improvement, void reduction, increase of fiber content, etc.

Also, thickness of the interlayer may be minimized to reduce stress concentration in the interlayer under loading. In addition, any level of interpenetration of the interpenetrating layers in the interlayer can improve bond strength.

### BRIEF DESCRIPTION OF THE DRAWINGS

In order that the invention may be more clearly understood, preferred embodiments thereof will now be described in detail by way of example, with reference to the accompanying drawings, in which:

FIG. 1 is a schematic representation of one embodiment of a process of bonding according to the present invention;

FIG. 2A is a schematic representation of an intermediate structure comprising a polypropylene/glass fiber composite interpenetrating layer bonded to and partially interpenetrating a fibrous interlayer;

FIG. 2B is a schematic representation of a composite comprising a thermoset polyester/glass fiber composite laminated to the intermediate structure of FIG. 2A;

FIG. 3A is a schematic representation of an intermediate structure comprising a polypropylene or maleic anhydride graft polypropylene adhesive interpenetrating layer bonded to and partially interpenetrating a fibrous interlayer, the adhesive also being bonded to a polypropylene/glass fiber composite substrate;

FIG. 3B is a schematic representation of a composite comprising a thermoset polyester/glass fiber composite laminated to the intermediate structure of FIG. 3A;

FIG. 4 depicts a scarf joint repair process of the present invention; and,

FIG. 5 depicts various possible textures of interlayer.

### EXAMPLES

Materials and Methods:

Lap shear strengths were determined by ASTM D3164-97.

PP is polypropylene (6100 SM Montell).

MAgPP (Polybond™ 3150, UniRoyal Chemicals) is maleic anhydride graft polypropylene.

PP/GF is a thermoplastic polypropylene/glass fiber composite made from commingled PP/GF in a woven fabric form with a GF concentration of more than about 65 wt % based on the weight of the PP/GF (Twintex™, Vetrotex St-Gobin).

PE/GF is a thermoset polyester/glass fiber composite (Polylite™ 32115-07, Reichhold).

Epoxy/GF is a thermoset epoxy polymer/glass fiber composite (MIA Poxy 100 and MIA Hardener 95, MIA).

TPE is a thermoplastic elastomer based on ethylene-propylene rubber (DSM Sarlink).

Krazy™ Glue is an adhesive comprising Ethyl 2-cyanoacrylate (Elmer's Production Canada Inc.).

G_M is a glass fiber mat with 2D random distribution (Airweave™ UHT800, Air Tech).

G_Fa is a glass fiber bi-layer fabric (Twill™ 2-2,120Oz/vg², MF Composites).

PE_M is a polyester fiber mat with 3D random distribution (Airweave™ N10, Air Tech).

Velcro™ tape is a polyamide fiber strip (Velcro™ Canada Inc.)

### Example 1

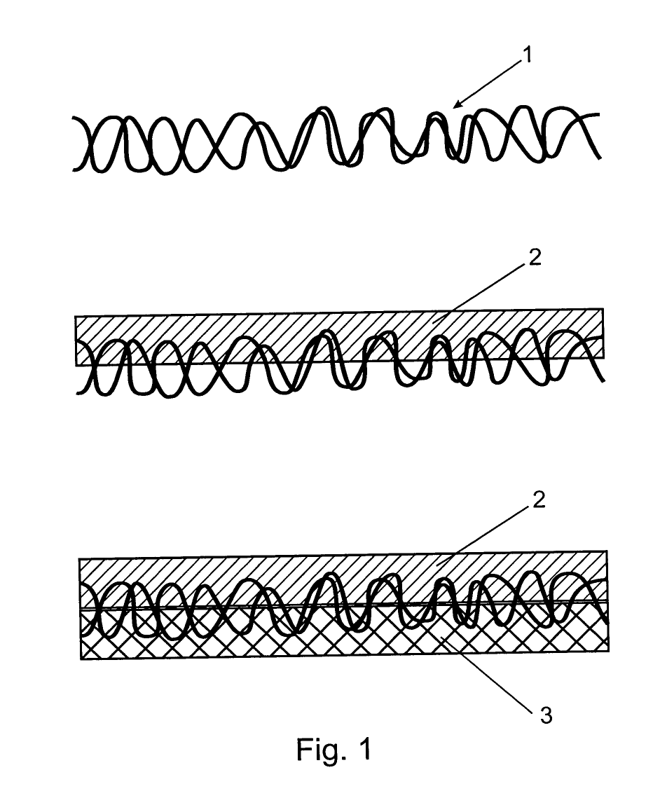

FIG. 1 is a schematic representation of one embodiment of a bonding process according to the present invention. A fibrous material is provided which will act as a porous interlayer (1) in the composite. A first interpenetrating layer (2) is then laminated onto the interlayer such that the first interpenetrating layer (2) partially interpenetrates the interlayer leaving some of the fibrous material free for interpenetration by a second interpenetrating material. A second interpenetrating layer (3) is then laminated onto the interlayer to complete the interpenetration of the interlayer. The first interpenetrating layer (2) and second interpenetrating layer (3) are each compatible with a first substrate (not shown) and a second substrate (not shown), respectively, to which the interpenetrating layers are bonded.

### Example 2

Sixteen composites of the present invention and two comparative composites were assembled as outlined in Table 1. Assembled thermoset composites were controlled to have a fiber concentration of about 50 wt % based on the weight of the composite.

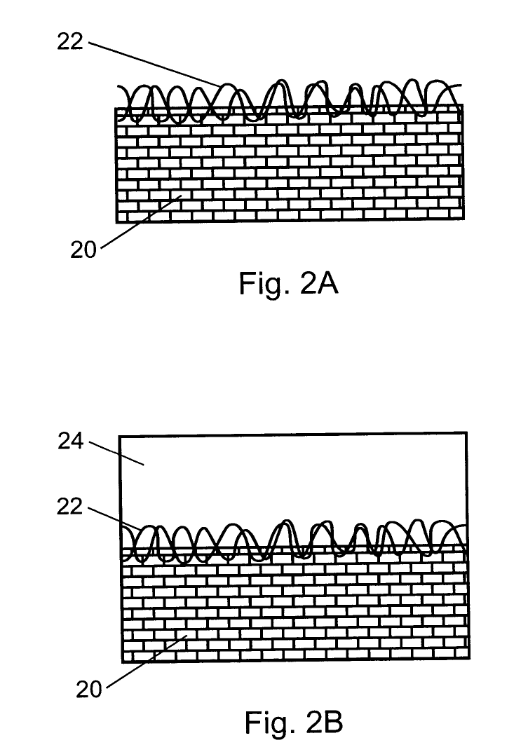

For five samples (i.e. Samples 1-3), the surface of a polypropylene/glass fiber composite (PP/GF) substrate was first melted using a hot plate (for Samples 1, 2-HP and 3), an infrared beam (for Sample 2-IR) or a heat gun (for Sample 2-HG) and a fibrous interlayer was applied directly to the melted surface of the PP/GF with the aid of a roller. Thus, the melted surface of the PP/GF substrate also acts as an interpenetrating layer. The resulting intermediate structure is depicted in FIG. 2A, in which the PP/GF interpenetrating layer (substrate) (20) partially interpenetrates the fibers of the interlayer (22) while some of the fibers remain free for bonding to another interpenetrating layer. The interlayer used in Sample 1 was a glass fiber mat having 2D random distribution. The interlayer in Samples 2-HP, 2-IR and 2-HG was a glass fiber bi-layer fabric. The interlayer for Sample 3 was a polyester fiber mat having 3D random distribution. Each of the intermediate structures of Samples 1-3 were then laminated on the opposing face of the interlayer with a thermoset polyester/glass fiber composite (PE/GF) by the hand lay-up method. As depicted in FIG. 2B, the resulting composite comprises a PP/GF layer (20) and a PE/GF layer (24), each partially interpenetrating the fibers of an interlayer (22).

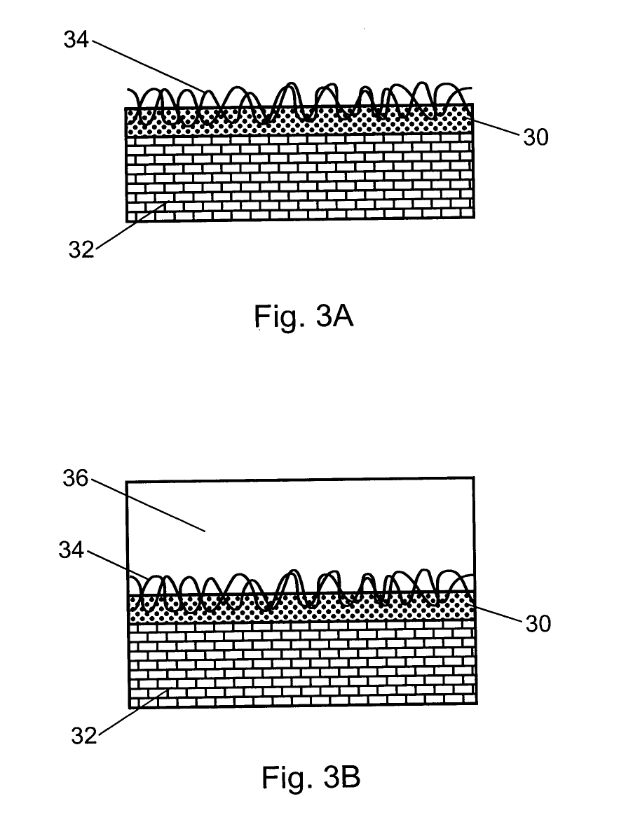

For nine samples (i.e. Samples 4-10), a fibrous interlayer was first partially interpenetrated by polypropylene (PP) adhesive (Samples 4-8) or maleic anhydride graft polypropylene (MAgPP) adhesive (Samples 9-10). Interpenetration was accomplished by melting the surface of the PP or MAgPP using a hot plate (for Samples 4, 5-HP and 6-10), an infrared beam (for Sample 4-IR) or a heat gun (for Sample 4-HG) with the fibrous interlayer applied directly to the melted surface with the aid of a roller. The PP or MAgPP was then adhered to the surface of a PP/GF composite substrate to provide an intermediate structure as depicted in FIG. 3A, in which a PP or MAgPP interpenetrating layer (30) partially interpenetrates a fibrous interlayer (34) with the PP or MAgPP interpenetrating layer (30) also adhered to a PP/GF composite substrate (32). The interlayer used in Samples 4, 7 and 9 was a glass fiber mat having 2D random distribution. The interlayer in Samples 4-HP, 4-IR , 4-HG, 8 and 10 was a glass fiber bi-layer fabric. The interlayer for Sample 6 was a polyester fiber mat (PE_M) having 3D random distribution. Each of the intermediate structures for Samples 4-6 was then laminated on the opposing face of the interlayer with a polyester/glass fiber composite (PE/GF) by the lay-up method. Each of the intermediate structures for Samples 7-10 was laminated on the opposing face of the interlayer with a thermoset epoxy/glass fiber composite (Epoxy/GF) by the hand lay-up method. As depicted in FIG. 3B, the resulting composite comprises a PP/GF layer (32) bonded to a PP or MAgPP interpenetrating layer (30) partially interpenetrating a fibrous interlayer (34), and, a PE/GF or Epoxy/GF layer (36) also partially interpenetrating the fibrous interlayer (34).

Sample 11 has been prepared by adhering PE_M on molten MAgPP first, then the opposing face of the interlayer was impregnated with thermoset Epoxy/GF composite by lay-up method. Finally, the whole structure was introduced into the mold. The MAgPP face was put in contact with PP/GF composite and the assembled structure was made by compression.

Sample 12 was prepared by partial impregnation of the interlayer by Epoxy/GF composite using lay-up method. An MAgPP film was then applied on the opposing face of the interlayer and finally molded with PP/GF composite by compression molding.

The lap shear strengths of Samples 1, 2-HP, 3, 4, 5-HP and 6 are listed in Table 1. These samples compare the lap shear strengths of composites assembled from three different interlayers using two alternative methods of the present invention. In one method, the interlayer was applied directly to the melted surface of a PP/GF composite, while in the other method, PP adhesive was used as an interpenetrating layer, which was adhered to a PP/GF substrate. The lap shear strengths varied between about 3.44 MPa and 6.52 MPa.

The lap shear strengths of Samples 2-HP, 2-IR, 2-HG, 5-HP, 5-IR and 5-HG are depicted in Table 1. These Samples compare the effect of three different melting techniques on lap shear strength of composites of the present invention. The three melting techniques, i.e. hot plate, infrared beam and heat gun, generally result in composites having comparable lap shear strengths although the hot plate did perform marginally better. It is also evident that direct application of a melted PP/GF composite to a fibrous interlayer resulted in composites with inferior lap shear strengths when compared to composites constructed using a polypropylene adhesive as an interpenetrating layer interlocked with a fibrous interlayer and then adhered to a PP/GF composite substrate. This may be due to some inhomogeneity of the PP/GF composite surface. However, heat guns are generally preferred for assembling or repairing large parts due to its greater heating efficiency. Therefore, choice of heating method will depend on the particular application.

The lap shear strength of Samples 7, 8, 9 and 10 are listed in Table 1. It is evident that composites using glass fabric as the interlayer tend to have better lap shear strength than composites using glass mat. It is also evident that using MAgPP adhesive provides some benefit with respect to lap shear strength over PP adhesive when glass fabric is used as the interlayer, perhaps due to a better MAgPP/GF interface as compared to a PP/GF interface. Comparing Samples 8 to 4 or 7 to 5-HP, it is also evident that the use of thermoset epoxy/glass fiber composites as an interpenetrating layer results in a composite with better lap shear strength than a similar composite using thermoset polyester/glass fiber composites as the interpenetrating layer, perhaps due to the superior strength properties of an Epoxy/GF composite as compared to those of a PE/GF composite.

The lap shear strength of Samples 11 and 12 are listed in Table 1. The lap shear strengths of Samples 11 and 12 are greater than that of all the others. This is likely due to better control of the impregnation of the interlayer. The shear strength of Sample 12 is better than that of Sample 11 likely because when the interlayer has been partly impregnated by epoxy, it allows the epoxy matrix to further wet the PE_M fibers due to capillary effect of the liquid epoxy system. As a result, better mechanical interlock is made, thus increasing the bond strength.

Comparative Samples C1 and C2 were prepared by laminating a PE/GF or an Epoxy/GF composite directly on to a PP/GF composite by the hand lay-up method without using an interlayer. It is immediately apparent that the lap shear strengths of the two comparative samples are significantly inferior to any of the samples prepared in accordance with the present invention.

TABLE 1

| | | | | Lap Shear |
|---|---|---|---|---|
| | | | | Strength |
| Sample | Layer 1 | Layer 2 | Interlayer | (MPa) |
| 1 | PP/GF | PE/GF | G_M | 3.4 |
| 2-HP | PP/GF | PE/GF | G_Fa | 5.0 |
| 2-IR | PP/GF | PE/GF | G_Fa | 4.8 |
| 2-HG | PP/GF | PE/GF | G_Fa | 4.8 |
| 3 | PP/GF | PE/GF | PE_M | 3.6 |
| 4 | PP - adhered on PP/GF | PE/GF | G_M | 4.7 |
| | substrate | | | |
| 5-HP | PP - adhered on PP/GF | PE/GF | G_Fa | 6.5 |
| | substrate | | | |
| 5-IR | PP - adhered on PP/GF | PE/GF | G_Fa | 5.6 |
| | substrate | | | |
| 5-HG | PP - adhered on PP/GF | PE/GF | G_Fa | 5.9 |
| | substrate | | | |
| 6 | PP - adhered on PP/GF | PE/GF | PE_M | 4.2 |
| | substrate | | | |
| 7 | PP - adhered on PP/GF | Epoxy/GF | G_M | 7.2 |
| | substrate | | | |
| 8 | PP - adhered on PP/GF | Epoxy/GF | G_Fa | 8.3 |
| | substrate | | | |
| 9 | MAgPP - adhered on | Epoxy/GF | G_M | 7.1 |
| | PP/GF substrate | | | |
| 10 | MAgPP - adhered on | Epoxy/GF | G_Fa | 9.5 |
| | PP/GF substrate | | | |
| 11 | MAgPP - adhered on | Epoxy/GF | PE_M | 9.9 |
| | PP/GF substrate using | | | |
| | compression molding | | | |
| 12 | Epoxy/GF | MAgPP- | PE_M | 11.3 |
| | | adhered on | | |
| | | PP/GF | | |
| | | substrate using | | |
| | | compression | | |
| | | molding | | |
| C1 | PP/GF | PE/GF | none | 0.1 |
| C2 | PP/GF | Epoxy/GF | none | 0.3 |

### Example 3

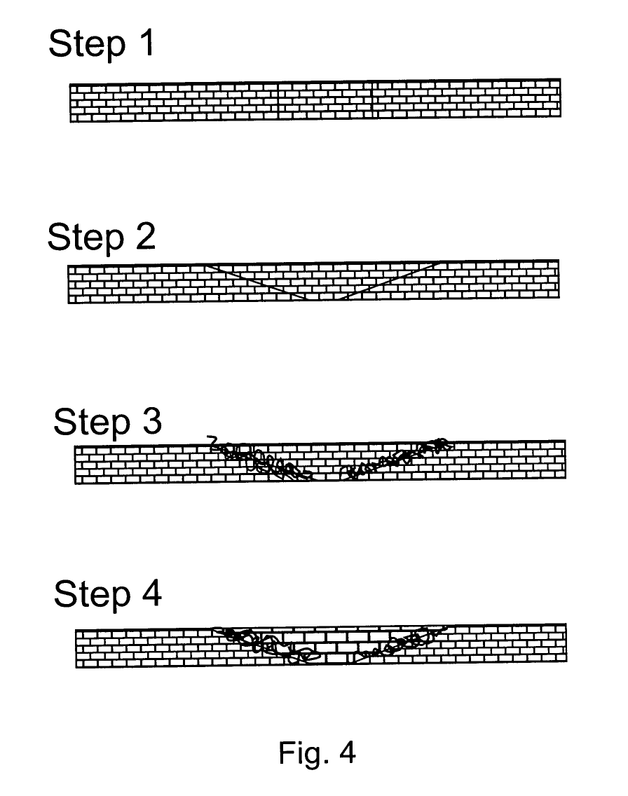

FIG. 4 depicts an example of a scarf joint repair process of the present invention. In Step 1, a damaged area of an article consisting of a commingled PP/glass fiber (PP/GF) composite having >65 wt % glass fiber is removed to form a gap. In Step 2, a bevel angle of about 2-10° is made on the edges of the article where the damaged area was removed. In Step 3, a glass fabric interlayer is applied to the beveled angles on the edges of the article where the damaged area was removed. The interlayer is applied by first melting the surface of the beveled angle and then applying the interlayer to the melted surface so that melted PP of the PP/GF composite partially interpenetrates the interlayer. In Step 4, an epoxy composite is applied into the gap so that an epoxy matrix fills the gap and interpenetrates the remainder of the interlayer. A strong bond is thus formed between the article and the epoxy polymer used to repair the damaged area. With a bevel angle of 6°, a bond strength of greater than 40 MPa can be achieved, which is higher than the tensile strength of a polypropylene matrix itself.

### Example 4

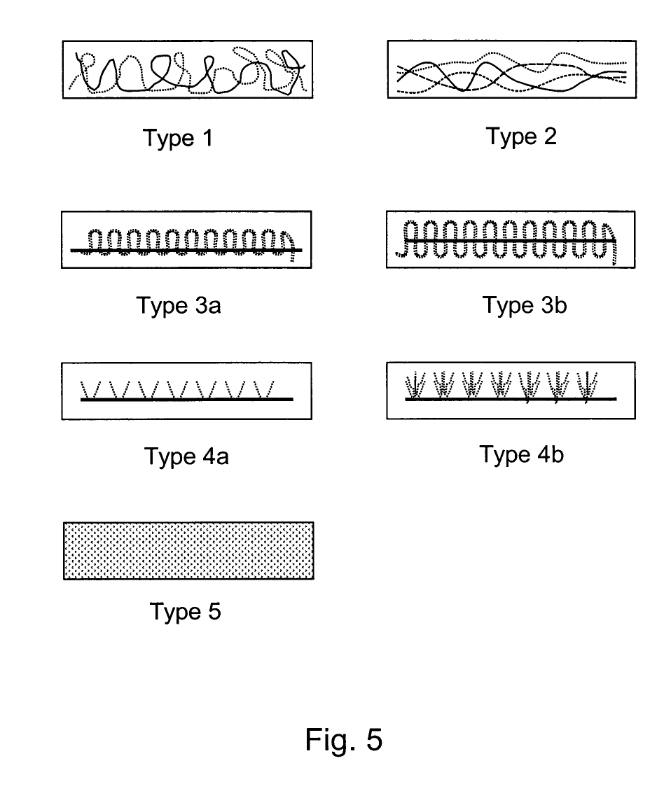

FIG. 5 depicts some, but not all, of the various possible textures that the interlayer may have. Type 5 depicts a porous interlayer of the open foam variety. The optimal texture depends on the specific application. For example, whether the main applying force is shear, peel or pulling will dictate the optimal interlayer to be used. Types 1 and 2 are good for most applications, although Type 1 tends to be better than Type 2. Types 3a and 3b tend to be more resistant to peel and pull. Types 4a and 4b are good for peel.

### Example 5

The non-scrim side of Velcro™ tape was glued to a PE_M mat using Krazy™ Glue. Subsequently, the PE_M interlayer was over-molded in a mold with TPE using compression molding at a temperature of 200° C. The thickness of the TPE layer at the end was about 5 mm. The overlap shear of the joint was over 12 MPa.

Other advantages which are obvious and which are inherent to the structure will be evident to one skilled in the art.

It will be understood that certain features and sub-combinations are of utility and may be employed without reference to other features and sub-combinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

Having described the invention, what is claimed is:

1. A composite comprising an interlayer disposed between a first interpenetrating layer and a second interpenetrating layer, the interlayer consisting essentially of a porous material, the first interpenetrating layer partially interpenetrating the interlayer, and the second interpenetrating layer partially interpenetrating the interlayer.

2. The composite according to claim 1, wherein the porous material is a fibrous mat, scrim or fabric, a pitted or perforated metal strip or block, or a porous clay.

3. The composite according to claim 1, wherein the porous material is a fibrous mat, scrim, fabric, sheet or strip.

4. The composite according to claim 3, wherein the fibrous mat, scrim, fabric, sheet or strip comprises glass fibers, metallic fibers, metallic oxide fibers, ceramic fibers, cellulose fibers, asbestos fibers, plastic fibers or hybrids thereof.

5. The composite according to claim 3, wherein the fibrous mat, scrim or fabric comprises glass fibers or polyester fibers.

6. The composite according to claim 1, wherein the interpenetrating layers are the same or different and each interpenetrating layer comprises a polymer, a metal or metal alloy, a glass, a ceramic, a composite thereof, or a combination thereof.

7. The composite according to claim 1, wherein the interpenetrating layers are the same or different and each interpenetrating layer comprises a thermoplastic polymer, a thermoset polymer, an elastomeric polymer, a composite thereof, or a combination thereof.

8. The composite according to claim 1, wherein the interpenetrating layers are different and each interpenetrating layer comprises a polypropylene, a thermoplastic polypropylene/glass fiber composite, a thermoset polyester, a thermoset polyester/glass fiber composite, a thermoset epoxy, a thermoset epoxy polymer/glass fiber composite, a maleic anhydride graft polypropylene, an ethylene-propylene rubber thermoplastic elastomer or an ethyl 2-cyanoacrylate adhesive.

9. The composite according to claim 1, wherein one or more substrates are bonded to one or more of the interpenetrating layers.

10. The composite according to claim 9, wherein the one or more substrates comprise a polymer, a metal or metal alloy, a glass, a ceramic, a composite thereof, or a combination thereof.

11. The composite according to claim 1, comprising more than one interlayer.

12. A process for bonding, the process comprising: providing an interlayer consisting essentially of a porous material; partially interpenetrating the interlayer with a first interpenetrating layer; and partially interpenetrating the interlayer with a second interpenetrating layer.

13. The process according to claim 12, wherein the porous material of the interlayer is laminated on to a melted surface of the first interpenetrating layer to thereby partially interpenetrate the interlayer with the first interpenetrating layer.

14. The process according to claim 13, wherein the first interpenetrating layer is provided in film form.

15. The process according to claim 12, further comprising bonding one or more substrates to one or more of the interpenetrating layers.

16. The process according to claim 12, wherein the interpenetrating layers are bonded to the interlayer sequentially.

17. The process according to claim 12, wherein the first interpenetrating layer is an adhesive to which a substrate is subsequently bonded.

18. The process according to claim 12, wherein the first interpenetrating layer is formed by coating a monomer or monomers or a polymer solution on to the porous material followed by curing the monomer or monomers or evaporating solvent from the solution.

19. The process according to claim 12, wherein a wet mixture of a ceramic material is coated on to the porous material followed by drying to form a green body.

20. The process according to claim 19, wherein the green body is sintered or hot pressed.

21. A composite comprising an interlayer disposed between a first interpenetrating layer and a second interpenetrating layer,
the interlayer consisting essentially of a porous fibrous mat, scrim, fabric, sheet or strip comprising glass fibers and/or polyester fibers,
the first interpenetrating layer partially interpenetrating the interlayer and comprising a polypropylene, a thermoplastic polypropylene/glass fiber composite, a thermoset polyester, a thermoset polyester/glass fiber composite, a thermoset epoxy, a thermoset epoxy polymer/glass fiber composite, a maleic anhydride graft polypropylene, an ethylene-propylene rubber thermoplastic elastomer or an ethyl 2-cyanoacrylate adhesive, and
the second interpenetrating layer partially interpenetrating the interlayer and comprising a polypropylene, a thermoplastic polypropylene/glass fiber composite, a thermoset polyester, a thermoset polyester/glass fiber composite, a thermoset epoxy, a thermoset epoxy polymer/glass fiber composite, a maleic anhydride graft polypropylene, an ethylene-propylene rubber thermoplastic elastomer or an ethyl 2-cyanoacrylate adhesive.

22. The composite according to claim 21, further comprising a substrate adhered to one or more of the interpenetrating layers.
